(19) United States
(12) Patent Application Publication
(10) Pub. No.: US 2015/0015665 A1
(43) Pub. Date: Jan. 15, 2015

(54) WIDE ANGLE CAMERA WITH AUTOMATED PANORAMIC IMAGE CAPTURE

(71) Applicant: Howard Unger, Henderson, NV (US)

(72) Inventor: Howard Unger, Henderson, NV (US)

(21) Appl. No.: 14/501,515

(22) Filed: Sep. 30, 2014

Related U.S. Application Data
(63) Continuation of application No. 13/288,737, filed on Nov. 3, 2011.
Application No. 13/288,737 is a continuation-in-part of application No. 13/164,358, filed on Jun. 20, 2011, now Pat. No. 8,773,501.

(51) Int. Cl. H04N 5/232

(52) U.S. Cl. CPC H04N 5/23238
USPC 348/37

(57) ABSTRACT

A motorized camera provides one or more capture sequences for capturing radially distorted wide angle images of objects detected within a plurality of its detection zones. A sequence may include actions to move or reposition an imaging device of the camera to one or more locations, and to capture one or more radially distorted images before, during, or as the imaging device is moved. The motorized camera comprises a wide angle imaging device for capturing radially distorted images having a wide field of view. An image processor converts the radially distorted images captured by the wide angle imaging device into rectilinear images.

### CROSS-REFERENCE TO RELATED APPLICATION

This application is a continuation of U.S. patent application Ser. No. 13/288,737, filed Nov. 3, 2011, which is a continuation-in-part of U.S. patent application Ser. No. 13/164,358, filed Jun. 20, 2011, now U.S. Pat. No. 8,773,501.

### BACKGROUND OF THE INVENTION

1. Field of the Invention

The invention relates to automated image capture systems and in particular to a wide angle camera with automated panoramic capture sequences.

2. Related Art

Photographs and other captured images are widely used to record events, objects, animals, and people. As such, captured images are highly desirable for personal use and for commercial use, especially if the captured image is a high quality image.

Capturing a desired image can be difficult. Environmental conditions such as the amount and color of available light can have negative effects on a photograph or other captured image. In addition, depending on the situation, there may be few vantage points which can be easily, safely, or conveniently used to capture an image. Sometimes, the ideal vantage point may be hazardous or simply inconvenient. For example, few photographers may wish to spend a night in the mountains or a day in the desert to capture an image. Moreover, the object to be captured may move unpredictably. Therefore to capture a desired image of such an object a great deal of time and patience is often required.

From the discussion that follows, it will become apparent that the present invention addresses the deficiencies associated with the prior art while providing numerous additional advantages and benefits not contemplated or possible with prior art constructions.

### SUMMARY OF THE INVENTION

A camera capable of executing one or more capture sequences where one or more images are captured is disclosed herein. The camera may have a wide angle imaging device which can automatically position itself to target a particular area according to a capture sequence. The camera may detect the presence of an object of interest to initiate a capture sequence. A capture sequence may provide instructions regarding where to capture images in response to the presence of an object, and to automate activation/deactivation or other functions of various components of the camera, such as illuminators. The camera may have a portable design, which combined with the capture sequences, allow for unattended operation for long periods of time. This is highly advantageous in capturing images of objects of interest.

The camera may have various configurations. For example, in one embodiment, a camera for automatically capturing one or more images may be provided. Such a camera may comprise an enclosure configured to support one or more components of the camera, a plurality of sensors arranged to detect an object in one or more of a plurality of detection zones, and a wide angle imaging device mounted within the enclosure and configured to capture one or more radially distorted images of one of more of the plurality of detection zones when an object is detected in one or more of the detection zones by one or more of the plurality of sensors. An image processor may be used to convert the radially distorted images into one or more rectilinear images. A storage device may store the rectilinear images.

The enclosure may be configured to mount to various structures. For example, in an outdoor embodiment the enclosure may be secured to a tree or other outdoor structure. The enclosure may be camouflaged, such as by having camouflage paint or other camouflage coating on at least its exterior surface (or a portion thereof).

In rotatable or movable embodiments, a rotating mount having a plurality of positions corresponding to the plurality of detection zones may support the wide angle imaging device, and a motor may be provided to move the rotating mount. A plurality of illuminators, each of the plurality of illuminators positioned to illuminate at least one of the plurality of detection zones.

One or more processors may be configured to receive input from at least one of the plurality of sensors and to execute one or more capture sequences. The input from the sensors may identify at least one of the detection zones where an object has been detected.

The capture sequences may be configured in various ways. For example, the capture sequences may be configured to activate the motor to move the imaging device to at least one of the plurality of positions that corresponds to at least one detection zone where the object was detected, and capture the radially distorted images at such position(s) with the wide angle imaging device.

Capture sequences may also include activating the motor again to move the imaging device to at least one of the plurality of positions that corresponds to a different one of the plurality of detection zones than the detection zone(s) where the object was detected, and capturing one or more additional radially distorted images at these different position(s). The additional radially distorted images may be converted into one or more additional rectilinear images by the image processor. The capture sequences may further comprise instructions to tag the rectilinear images without tagging the additional rectilinear images to make the rectilinear images readily identifiable from the additional rectilinear images.

In another exemplary embodiment, a wildlife camera configured to capture one or more images of wildlife according to one or more capture sequences may be provided. Such a camera may comprise an enclosure configured to prevent moisture infiltration to an internal compartment of the enclosure, one or more batteries secured within the enclosure and configured to power the wildlife camera, and a plurality of sensors configured generate sensor information identifying at least one of a plurality of detection zones in which wildlife has been detected. The wildlife may be one or more animals for instance. Similar to above, a mount may be provided to secure the wildlife camera to a tree.

A wide angle imaging device configured to capture one or more radially distorted images of one or more of the plurality of detection zones may be provided along with one or more capture sequences comprising instructions to capture the radially distorted images of at least one of the plurality of detection zones identified in the sensor information with the wide angle imaging device. One or more illuminators may be provided as well. If provided, the capture sequences may further comprise instructions to activate at least one of the illuminators based on various criteria such as ambient light level and/or a time of day.

One or more processors may also be provided. The processors may be configured to receive the sensor information and execute at least one of the capture sequences based on the sensor information, and convert the radially distorted images into one or more rectilinear images. It is noted that the processors may also be configured to stitch together the rectilinear images to form a panoramic image. In addition, the processors may be configured to tag one or more of the rectilinear images containing an image of the at least one of the plurality of detection zones in which the wildlife has been detected.

It is contemplated that a motor may be configured to move the wide angle imaging device between each of a plurality of positions. Accordingly, the capture sequences may include instructions to move the wide angle imaging device to one or more of the plurality of positions with the motor and to capture one or more images with the wide angle imaging device at each of the positions. Such position(s) include at least one of the plurality of positions where wildlife has been detected as identified in the sensor information.

Various methods for of automatically capturing one or more images with the camera are disclosed herein as well. In one exemplary embodiment, a method of automatically capturing one or more images may be provided. Such method may comprise detecting the presence of wildlife within one or more detection zones using one or more sensors, capturing one or more radially distorted images of one or more of the detection zones with a wide angle imaging device at a first position when the sensors detect the presence of wildlife within the detection zones, converting the radially distorted images into one or more rectilinear images with an image processor in communication with the wide angle imaging device, and engaging and attaching to a portion of a tree via a mount of an enclosure of the camera. For example, the enclosure may be secured to the tree with a strap that is connected to the enclosure via the mount.

The wide angle imaging device may move to one or more second positions and capture one or more radially distorted images at the second positions. The first position may be associated with the at least one of the detection zones in which the object is detected while the second positions are not. The rectilinear images may be stored on a storage device. It is contemplated that an illuminator of the outdoor camera may be activated based on a criteria selected from the group consisting of a predefined ambient light threshold and a predefined time of day.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a front view of an exemplary camera;

FIG. 1B is a side view of an exemplary camera;

FIG. 1C is a perspective view of an exemplary camera;

FIG. 2A is a cross section view of an exemplary camera;

FIG. 2B is an internal view of an exemplary camera;

FIG. 3 is a block diagram illustrating exemplary components of a camera;

FIG. 4 illustrates an exemplary camera and its detection zones;

FIG. 5 is a flow diagram illustrating operation of an exemplary camera;

FIG. 6A is a block diagram illustrating exemplary components of a camera;

FIG. 6B is a block diagram illustrating exemplary components of a camera;

FIG. 7 illustrates an exemplary wide angle camera and its detection zones;

FIG. 8A illustrates and exemplary radially distorted image; and

FIG. 8B illustrates an exemplary rectilinear image.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the camera disclosed herein provides one or more detection zones in which objects may be detected, and then initiates one or more automated capture sequences to capture one or more images of the object. As will be described further below, the capture sequences capture a set or series of one or more images (i.e., photographs) at one or more camera positions to help ensure that an image of the subject is captured. This is so even if the subject is an animal, person, or object capable of moving or is actually moving.

The camera is also advantageous in that it is, in various embodiments, self powered and thus can be easily positioned at various locations. In addition, the camera is capable of monitoring one or more areas for some time. This allows the camera to detect and capture a number of objects or to “wait” for an object for some time. The camera may be ruggedized to withstand various environments including harsh environments. In this manner, the camera can be installed at virtually any location to capture images of various subjects over time.

As will become apparent from the disclosure herein, the camera is well suited for capturing images for a variety of surveillance purposes. For example, the camera may be used for security, such as by positioning or installing the camera to target exit and/or entry points to a building or other structure. In addition, the camera could be used indoors to protect valuable or other items from theft or tampering, such as by positioning or installing the camera at a vantage point where it may detect people, animals, or objects which enter one or more of its detection zones. The camera may also be used to capture wildlife images. For example, the camera may be installed in a forest or other setting to capture wildlife that enters one or more of its detection zones. In one or more embodiments, the camera may comprise a mount for attaching the camera to a tree, shrub, stick, rock, or other natural structure.

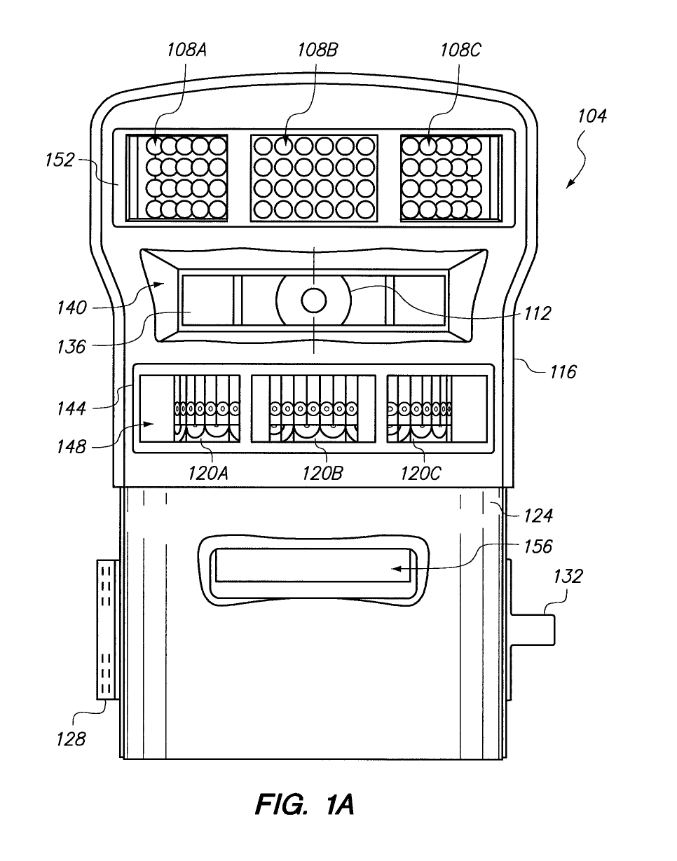

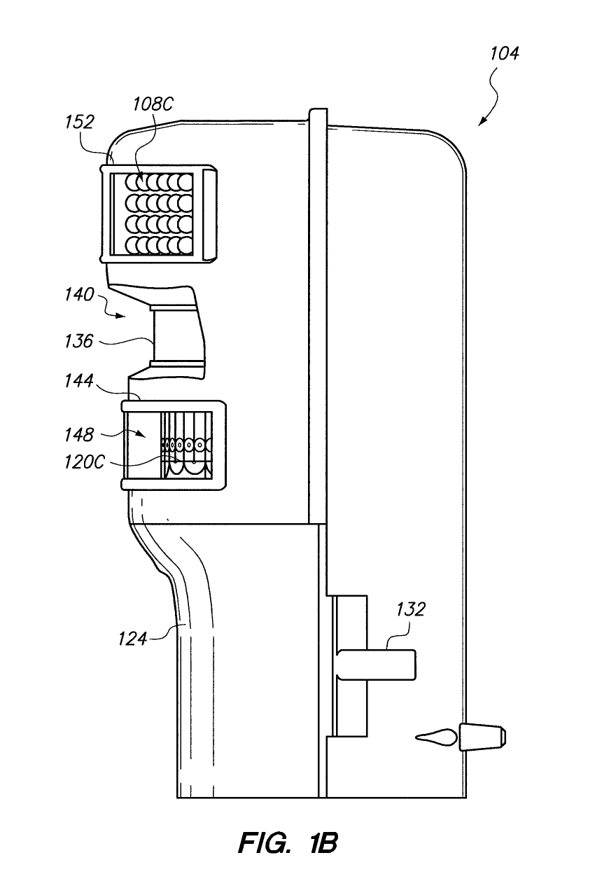

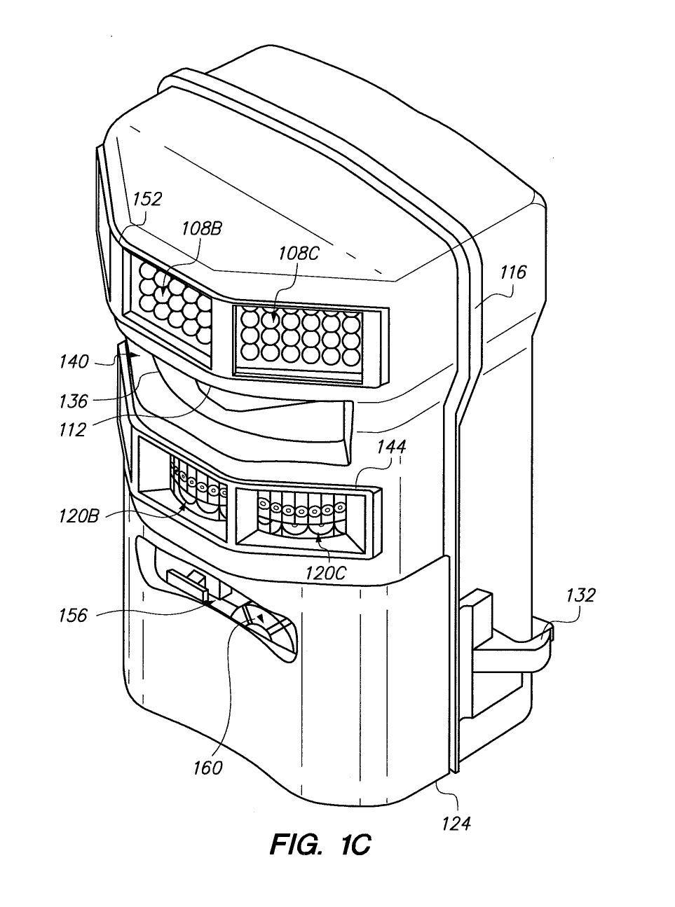

The camera will now be described with regard to FIGS. 1A-1C, which illustrate various views of the camera. FIG. 1A provides a front view, while FIGS. 1B and 1C respectively provide side and top perspective views of the camera 104. As can be seen, the camera 104 may comprise an enclosure 116 which supports or contains the components of the camera. The enclosure 116 may also be a structure which protects such components from the environment (e.g., humidity, moisture, extreme temperatures, physical impacts, dirt, debris, etc. . . . ).

For example, as can be seen, the enclosure 116 may form an outer shell of the camera 104 which supports and protects various components of the camera. In one or more embodiments, the enclosure 116 may be a rigid structure for such purposes. In addition, it is contemplated that the enclosure 116 may be waterproof or water resistant. In some embodiments, the enclosure 116 may have one or more locks or securing mechanisms which prevent unauthorized access or tampering via access panels or doors of the enclosure.

It is contemplated that the enclosure 116 may have features which camouflage or hide the camera 104, so that it is not readily visible. In some embodiments for example, the enclosure 116 may have a camouflage coating, such as paint or an outer covering having a camouflaged surface. In addition, the enclosure 116 may hide or conceal one or more conspicuous components of the camera. This is advantageous, especially where a subject to be captured may behave differently or avoid the camera 104. For example, wildlife may be spooked by a conspicuous looking device or surveillance may be difficult to gather if suspicious characters are aware of the camera 104.

In one or more embodiments, the enclosure 116 may be configured for mounting to various structures. In some embodiments for example, the enclosure 116 may be configured to attach to trees or limbs, branches, or other parts thereof. For example, the enclosure 116 may have one or more straps extending from or connected to its exterior surface. The straps may be used to tie the enclosure 116 to a tree such as by being tightened around a portion of the tree. In one or more embodiments, the enclosure may have one or more mounts for holding the straps to the enclosure. For example, in one or more embodiments, the straps may be held by hooks (open or closed) attached to an exterior surface of the enclosure 116.

As stated, the enclosure 116 may support or house various components of the camera 104. Referring to FIG. 1A for instance, it can be seen that the camera 104 may have one or more illuminators 108, an imaging device 112 for capturing images, and one or more sensors 120 supported by its enclosure 116. The enclosure 116 may have elements which protect these components. For example, a cover 152 may be provided to protect the illuminators 108. The cover 152 may comprise one or more transparent or translucent panels or the like which protect the illuminators 108. The panels may be mounted to the enclosure 116 or a frame thereof.

Similarly the one or more sensors 120 may be protected by their own cover 144. Such cover 144 may also comprise one or more transparent or translucent panels or the like. This permits sensor operation while protecting the sensors 120. It is contemplated that the cover 144 may be transparent to various signals. For example, the cover 144 may be transparent to radio frequencies, visible light, infrared light or other wavelengths of light. This allows a variety of sensors 120 to be used in the camera 104.

The imaging device 112 may be protected by a cover 136 of its own. Typically, this cover 136 will be transparent so as to allow the imaging device 112 to capture images through the cover 136 without degrading the image quality. It is contemplated that the imaging device 112 may be a camera or other image capture device. For instance an imaging device 112 may capture still or video images/photographs within various light spectrums, including visible and non-visible light spectrums. The cover 136 may be curved in one or more embodiments so that the cover does not introduce distortions as the imaging device 112 is positioned at various angles behind the cover.

Another protective aspect of the enclosure 116 involves its shape. For example, one or more areas of the enclosure may be inset to protect various components. To illustrate, the imaging device 112 may be mounted in an inset section 140 or portion of the enclosure 116. Likewise, the illuminators 108 and sensors 120 may also be mounted in one or more inset sections of the enclosure 116.

As stated above, the enclosure 116 may have one or more doors 124 or access panels that may be moved to provide access to an interior portion of the enclosure 116. It is contemplated that one or more hinges 128 or the like may be used to allow doors 124, access panels, or the like to be removable or movable. In one or more embodiments, one or more latches 132, locks, clasps or the like may be provided to secure the doors 124 or access panels in place once closed. These may be secured, such as by a locking mechanism, to prevent tampering.

Once open, door 124, access panel or the like may allow access to one or more internal components of the camera 104. For example, a user may add, remove, or replace camera media (such as one or more memory cards), batteries, and other internal components. There may be one or more input devices, such as buttons, behind a door 124 or access panel which allow the user to input camera settings and the like. In some embodiments, an internal display screen may be behind a door 124 or access panel. Such screen may allow users to interact with the camera 104, such as by receiving visual feedback in response to user input. In addition or alternatively, the screen may permit a user to review images taken by the camera 104. The door 124, access panel, or the like will typically remain closed during operation. In this manner, internal components are protected from tampering, weather, and other external forces.

The enclosure 116 also provides a framework or structure upon which various components of the camera 104 may be positioned at particular locations and orientations. Referring to FIG. 1C for example, it can be seen that the individual sensors 120A,120B,120C have been positioned in a convex configuration. As will be described further below, this allows the combined detection zones of the sensors 120A,120B,120C to span a wide swath of area. In addition, the detection zones may be continuous between the sensors 120A,120B,120C so as to prevent objects from avoiding detection.

FIG. 1C also shows that the illuminators 108A,108B,108C may be of the same or similar number as the sensors 120A,120B,120C and may have a similar or the same positioning/orientation. To illustrate, it can be seen in FIG. 1C that the illuminators 108A,108B,108C may be in a similar convex arrangement as the sensors 120A,120B,120C. This is beneficial in that an illuminator 108 may be used to provide illumination for the detection zone provided by its corresponding sensor 120. For example, an object detected in a detection zone provided by sensor 120C as well as the detection zone itself may be illuminated by illuminator 108C, which shares a similar or the same outward facing direction.

Likewise, the imaging device 112 of the camera 104 may be supported by the enclosure 116 such that it may move between positions to target each detection zone provided by the camera's sensors 120. For example, referring to FIG. 1A, the imaging device 112 may move to a left position to target a detection zone provided by sensor 120A, move to a center position to target the detection zone of sensor 120B, and move to a right position to target the detection zone of sensor 120C.

The imaging device 112 may move along a continuum between its leftmost and rightmost extents. In one or more embodiments however, predefined camera positions may be provided. Typically such positions will correspond to the arrangement of the sensors 120. For example, a predefined camera position may be one where the imaging device 112 is at the same angle as one of the sensors 120. In this manner, the imaging device 112 can capture a complete view of the sensor's detection zone. This increases the likelihood that an object detected in such detection zone will be captured by the imaging device 112.

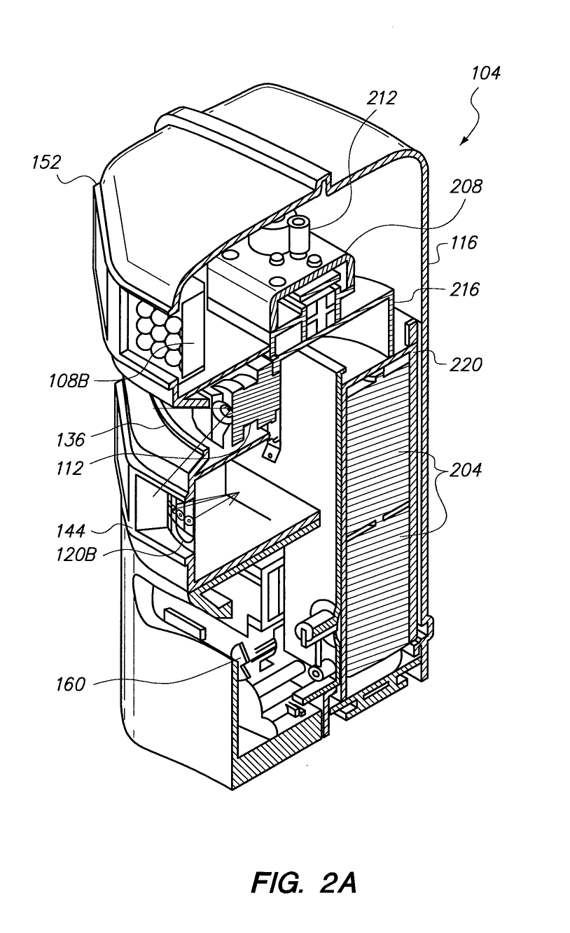

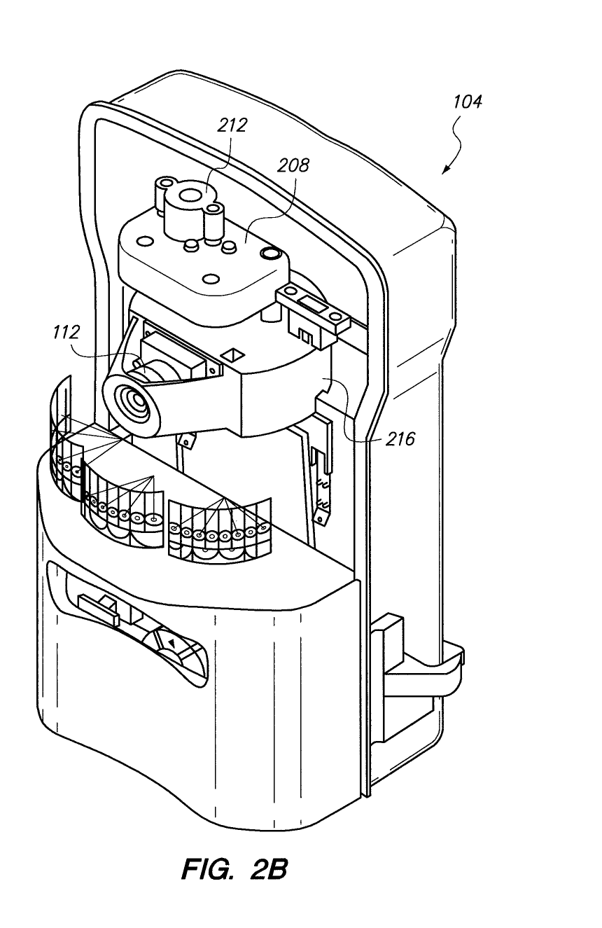

FIGS. 2A-2B illustrate the interior composition of the camera 104. As can be seen, the enclosure 116 may have one or more interior supports and compartments for housing and/or supporting the various components of the camera 104. For instance, the enclosure 116 may have a battery compartment 220 for housing one or more batteries 204 such that they properly engage one or more leads or terminals of the camera 104 to provide electrical power thereto. It is noted that other power sources may be used with the camera 104. For example, one or more solar panels may be attached to an exterior portion of the enclosure 116.

A portable power source, such as batteries 204, is advantageous in that it permits the camera 104 to be easily deployed at virtually any location. One reason for this is that the camera 104 can utilize its own power source and thus do away with external connections. This allows the camera to be encapsulated within its enclosure 116 and thus allows the camera 104 to be deployed simply by positioning it in a desired location and turning it on.

For example, the camera 104 could be deployed simply by placing it on a table, shelf, or other surface while ensuring its imaging device faces an area of interest (e.g., an area containing valuable items, where suspicious activity may occur, where an object (e.g., person or wildlife) may appear. The camera 104 may then utilize its battery power to wait for an object to be present, detect the object, and capture one or more images of the object. As can be seen (and as will be detailed further below), the camera 104 can be left unattended to capture images for a user.

The enclosure 116 may have a control compartment 232 as well. The control compartment 232 may contain various electronic devices, such as one or more controllers or microprocessors that govern the operation of the camera 104. In addition or alternatively, one or more input buttons 160 or other input devices could be at or in the control compartment 232. One or more output devices, such as display screens, speakers, or the like could also be mounted to or within the control compartment 232.

A sensor compartment 224 may be provided to house one or more sensors 120. Likewise, an optics compartment 228 may be provided to house one or more illuminators 108, the imaging device 112 or both.

It is noted that an enclosure 116 may have a variety of compartments other than those described above. In addition, various combinations of components may be installed in or at a particular compartment. Moreover, it is noted that a compartment need not fully enclose its associated components. For example, a compartment or section of the enclosure 116 may be defined by a support plate or other support/mount to which one or more components may be mounted.

As its name suggests, the camera 104 may have support various rotating or moving parts. For instance, the imaging device 112 may be mounted to a carrier mount 216. Typically, the carrier mount 216 will move, such as by rotating, to position the imaging device 112 at a desired position. Referring to FIGS. 1A-1C for example, the imaging device 112 may be rotated or moved horizontally (i.e., side to side) from the location shown in these figures. As will be described further below, this permits the imaging device 112 to execute one or more capture sequences where the imaging device is positioned at various positions to capture one or more images.

The carrier mount 216 may be configured as an enclosure and/or support for the imaging device 112. As shown for example, the carrier mount 216 encloses the imaging device 112 while supporting the imaging device. The carrier mount 216 may be rotatably mounted so as to allow it and the imaging device 112 to be moved. For example, in one or more embodiments, the carrier mount 216 may pivot on an axel, stem, or the like extending from a mounting surface of the enclosure 116 into the carrier mount, or vice versa.

The carrier mount may 216 may work in cooperation with a motor 212 and drive assembly 208. The drive assembly 208 will typically be configured to transfer power from the motor 212 to the carrier mount 216 so as to move the carrier mount. For example, the drive assembly 208 may comprise one or more gears, drive belts, and the like to transfer power from the motor 212. It is noted that the drive assembly 208 may be optional in some embodiments, since the motor 212 may be directly coupled to the carrier mount 216.

The drive assembly 208 may be configured to provide a mechanical advantage to the motor 212, such as by including one or more gears, pulleys, sprokets, or the like. In this manner, a smaller motor 212 may be used to reduce noise and size requirements. In addition, it is contemplated that the drive assembly 208 may reduce the power requirements for moving the carrier mount 216 and imaging device 112, thus preserving battery life.

It is noted that the coupling between the motor 212 and carrier mount 216 may also help support the carrier mount. For example, a drive shaft may extend between the motor 212 or the drive assembly 208 and the carrier mount 216. In this manner, the drive shaft (or other coupling element) can at least help rotatably secure the carrier mount 216.

The carrier mount 216, motor 212, and drive assembly 208 may be configured to move silently. In this manner, the motion of the imaging device is difficult or impossible to detect thereby allowing images of various objects to be captured without their knowledge. This is so even if the object is an animal or person with particularly sensitive hearing.

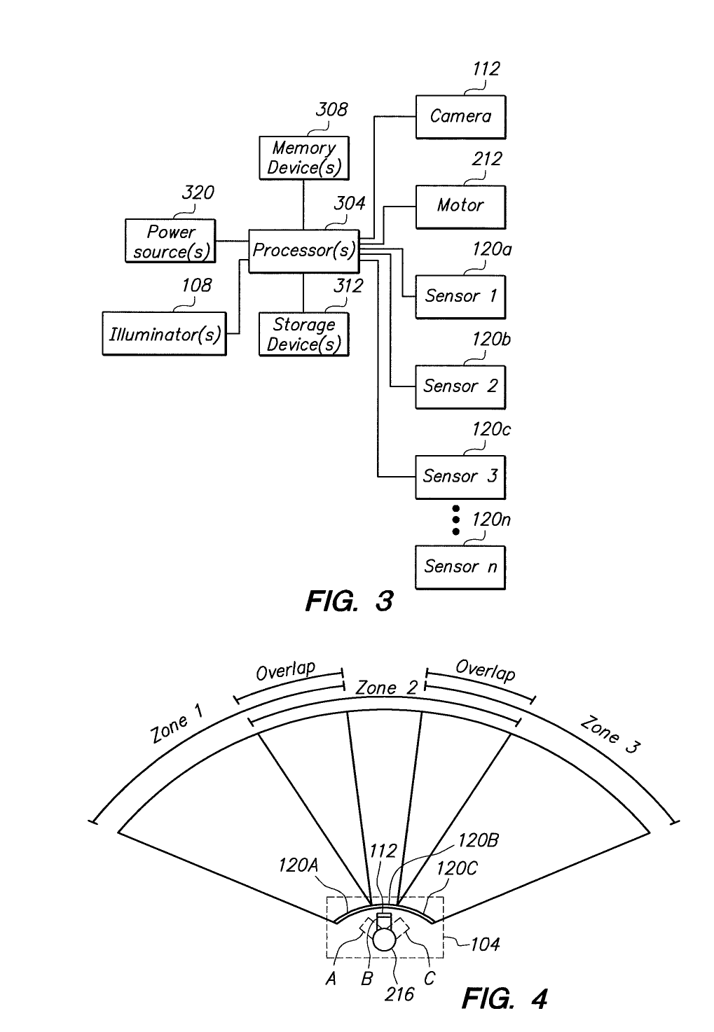

FIG. 3 is a flow diagram illustrating electronic components of an exemplary camera. As can be seen, such components may include one or more processors 304, memory devices 308 and/or storage devices powered by a power source 320, such as one or more batteries. It is noted that various power sources could be used including solar panels, external generators, or grid power.

In general, a processor 304 will be configured to receive input, process such input, and provide an output which governs the operation of the camera or components thereof to provide the functionality of the camera as disclosed herein. The processor 304 may execute one or more instructions to provide such functionality. In some embodiments, the instructions may be machine readable code stored on a memory device 308 or storage device 312 accessible to the processor 304. Alternatively or in addition, some or all of the instructions could be hardwired into the processor 304 itself. It is noted that the instructions may be upgradable such as by replacing old instructions with new ones.

The memory devices 308 may be temporary storage such as RAM or a cache, while the storage devices 312 may be more permanent storage such as a magnetic, flash, or optical storage device. It is contemplated that the storage device 312 may utilize removable media or may be remote storage accessible by the processor 304 via one or more communication links in one or more embodiments. It is noted that, either one or both the memory device 308 and storage device 312 may be provided in some embodiments.

As can also be seen, the processor 304 may be in communication with various other devices. For example, the processor 304 may communicate sensor information with one or more sensors 120. In general, the sensors 120 are configured to detect objects that come within their range. Sensors 120 of various types may be used. For example, an infrared sensor may be used to detect objects, such as wildlife, people, or other things based on the heat they emit. The infrared sensor may be passive or active in various embodiments. Other sensors 120 include radiofrequency sensors, audio sensors, vibration sensors, motion sensors, and the like. In general, the sensors 120 will be configured to generate sensor information which identifies whether or not a desired object has been detected. It is noted that the sensors 120 may be selected or configured to detect particular objects. For example, passive infrared sensors 120 may be used to detect the presence of wildlife or people, while radiofrequency or other sensors may be used to detect objects, such as vehicles, weapons, or the like. It is contemplated that different types of sensors 120 could be used in a single camera. Alternatively, all the sensors 120 may be of the same type.

The processor 304 may take into account which of the sensors 120 it is receiving sensor information from and perform different operations as a result. For example, as will be described further below, sensor information from a first sensor 120A may result in a first set of operations being executed while sensor information from a second sensor 120B may result in a second set of operations being executing. It can thus be seen that a number of different operations could be performed depending which of a plurality of sensors 120 has sent sensor information indicating the detection of an object.

In one or more embodiments, the sensor information may be used to generate output to a motor 212 such as to move or position the imaging device 112 at a particular location. For example, the processor 304 may receive sensor information and then communicate instructions or signals to the motor 212 to position the imaging device 112 at a particular location or at a sequence of locations. In one embodiment, the motor 212 may be instructed to rotate a number of full or partial revolutions to position the imaging device 112 to capture image(s) of an object. The processor 304 may also control the imaging device 112 to capture one or more images while the imaging device is being moved, before or after the imaging device has moved, or all three.

It is contemplated that the processor 304 may also activate an illuminator 108 to illuminate the scene to allow the imaging device 112 to capture a better image, such as by lighting the area. It is noted that the illumination may be visible or invisible light (e.g., infrared illumination). The processor may be in communication with a light sensor or the like to determine whether or not illumination is needed. Alternatively, the processor may consult an internal or other clock and a list of predefined light levels to determine how much sunlight is available.

Operation of the camera will now be generally described with regard to FIG. 4. FIG. 4 is a top view illustrating exemplary detection zones, Zones 1, 2, and 3, for an embodiment of the camera 104. As can be seen, a zone may correspond to a particular sensor 120. Stated another way, each sensor 120 may have its own detection zone. A detection zone may be the area in which a sensor 120 may be capable of detection objects. It is contemplated that a sensor 120 may have one or more lenses or other focusing devices to better define its detection zone.

In addition, the position of a sensor 120 may define its detection zone. For example, as shown in FIG. 4, it can be seen that the triangular detection zones, Zones 1, 2, and 3 are positioned based on the orientation of the sensors 120A,120B,120C at the camera 104. Referring to FIGS. 1A-1C and FIG. 4, it can be seen that the sensors 120 may be positioned in a curved arrangement, such as the convex arrangement shown. This arranges the detection zones of FIG. 4 in the pie shape as shown. It can also be seen that there may be some overlap of the detection zones. For example, Zones 1 and 2 partially overlap and Zones 2 and 3 partially overlap in FIG. 4.

As disclosed earlier, the imaging device 112 may have a number of predefined positions corresponding to the detection zones. This is also illustrated in FIG. 4. For example, Camera Positions A, B, and C may be defined for Zones 1, 2, and 3. Typically, the predefined camera positions will be locations at which the imaging device 112 is positioned to capture an image of the entire area contained within a zone (minus any areas behind physical obstructions through which the imaging device cannot see). In other words, the imaging device's 112 view at a predefined camera position may match that of a sensor's detection zone. In this manner, an object detected within a zone can be captured from that zone's predefined camera position.

The camera 104 may initiate one or more operations based on which zone or zones an object or objects are detected in. If an object is detected in an overlap area shared by two (or more zones), the operations to be performed may be selected based on a priority of zones. For example, if an object is in the overlap area of Zone 1 and Zone 2, operations associated with a priority zone may be performed. A list of zones by priority may be defined for each overlap area in one or more embodiments. Alternatively, it is contemplated that operations associated with all zones including the object may be initiated.

In general, the operations comprise one or more sequences of camera actions (capture sequences) initiated as a result of object detection. Since the camera 104 may determine which one (or more) of its sensors 120 detected an object, different capture sequences may be initiated accordingly. Typically, the capture sequences will be defined by one or more instructions, such as in the form of machine readable code, provided to the camera 104.

As described briefly above, a capture sequence may include one or more movements of the camera, activation of illumination device(s), image capture, or various combinations thereof. In addition a capture sequence may include image processing, as will be described below. Some examples of capture sequences are now provided with regard to FIG. 4.

### Example Sequence 1

If an object is detected in a detection zone, the imaging device may be moved to a preset location targeting that detection zone or an area therein. An image or multiple images may then be captured. Depending on one or more light level thresholds, an illuminator may be activated to provide illumination as the image is captured. It is noted that the level of illumination may be adjusted based on the light level around the camera. The illuminator may be activated for various capture sequences.

### Example Sequence 2

If an object is detected in a detection zone, the imaging device may move from its current location to target the zone in which the object has been detected. One or more images may be captured during this motion. The imaging device's motion may be stopped or momentarily stopped to capture these images. For example, if the imaging device currently points at Zone 3 and an object has been detected in Zone 1, the imaging device may capture one or more images at each zone as it moves from Zone 3 to Zone 1. Once at the target zone, one or more images may be captured as well.

### Example Sequence 3

If an object is detected in a detection zone, the imaging device may initiate a predefined sequence of movements and image captures. For example, if an object is detected at Zone 2, the imaging device may initiate a sweep sequence from Zone 3 to Zone 1 (or vice versa) capturing one or more images as it moves. It is contemplated that once the images are captured (in this and other examples), they may be processed by the imaging device. For example, the images captured during the movement from Zone 3 to Zone 1 (or vice versa) may be automatically stitched together to form a panorama, such as by the processor of the camera 104.

### Example Sequence 4

If an object is detected in a detection zone, the imaging device may capture at least one image in that zone and its adjacent zone or zones. For example, if an object is detected in Zone 1, the imaging device may be moved to Zone 1 (if not already there) to capture one or more images, the imaging device may then be moved to Zone 2 to capture one or more images. As another example, if an object is detected in Zone 2 the imaging device may capture one or more images in Zone 2 and them move to Zone 1 and/or Zone 3 to capture one or more images there.

### Example Sequence 5

If an object is detected in an overlap area, the imaging device may capture one or more images in the overlapping zones. In other words, if an object is detected in two or more zones, one or more images may be captured in each zone in which the object is detected. For example, one or more images may be captured with the imaging device targeting Zone 3 and Zone 2, if an object is detected in the overlap area shared by Zone 3 and Zone 2.

Once one or more images have been captured, they may be saved, such as to a storage device of the camera. For example, the images may be saved to a flash memory, hard drive, optical disc, or other medium. As stated, image processing may occur after an image has been captured. It is contemplated that an original captured image and its processed counterpart may be stored. In some embodiments, images may be combined, such as to form a panoramic image. The combined image may be stored on a memory device as well.

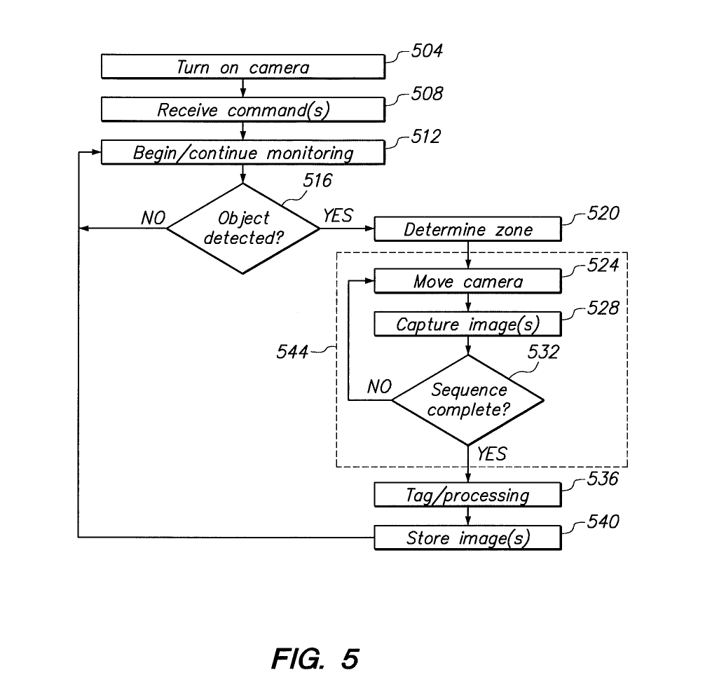

Additional details regarding operation of an exemplary camera will now be described with regard to the flow diagram of FIG. 5. It is noted that though presented in a particular order, one or more of the steps in the following may occur in various orders.

At a step 504, the camera may be turned on or activated. At a step 508, one or more commands may be received, such as via one or more input devices of the camera. It is contemplated that an external device could be used as well or instead. For example, a computer, handheld, or other device could be used to input or upload or otherwise provide commands to the camera via a communication link or a removable memory device.

The commands may be used to configure the camera. For example, a user may set the time, date, image quality, image size, and other parameters. It is contemplated that various timers may be established as well. For example, one or more timers may be set to automatically turn on or off the camera (or activate/deactivate its monitoring or image capture functions) at various times or dates. This helps preserve or conserve power, and may be used to help ensure that the object a user desires to capture is more likely to be captured. For example, to capture nocturnal wildlife, one or more timers may be set to activate the camera at night. This increases the likelihood that nocturnal wildlife is captured, saving power as well as storage capacity. This in turn extends the operational time of the camera in the field before additional power or storage capacity is needed.

In one or more embodiments, commands (or other input) may be received to program one or more image capture sequences. In general, such commands will define the operation of the imaging device when an object is detected. For example, as disclosed above, the imaging device may be moved to a particular index or position to capture one or more images in one or more zones as a result of an object being detected. Thus, the capture sequences may comprise particular imaging device movements, image capture actions, illuminator actions and other operations that occur when an object is detected by the camera's sensors. As stated above, different sequences may be defined based on the zone or zones in which an object is detected. In addition, the sequences may include conditional instructions or operations. For example, an illuminator action may be defined to activate an illuminator only if a light level threshold (or other condition) is met.

In general, the imaging device movements of a capture sequence will comprise instructions to move an imaging device from one position to another. In some embodiments, the camera may be capable of being positioned in discrete locations along a continuum. For example, as shown in FIG. 1 and FIG. 4, there are three sensors 120, each having their own position and orientation, which define three detection zones, Zones 1-3. Therefore, in this example, the imaging device 112 may have three discrete positions (e.g., left position, center position, right position) corresponding to each of the zones. The imaging device movements in this example may be configured to allow the imaging device to move between these fixed positions. It is noted that fewer or additional sensors, detection zones, and imaging device positions (other than the three described above) may be provided in various embodiments of the camera.

In general, the image capture actions of a capture sequence instruct the imaging device to capture one or more images. The image capture actions may define a number of images to capture once the imaging device is at a particular location. It is contemplated that the image capture actions may include one or more conditional operations that may be executed if particular conditions are met. For example, the imaging device may be instructed to capture additional images if lighting conditions are dim or otherwise undesireable, such as to increase the likelihood that a quality image of an object is captured in such conditions.

In some embodiments, the image capture actions may define settings for the imaging device. For example, exposure, zoom, and focus could be defined. Alternatively, one or more of these could be automatically set by the camera. Since it may be difficult to properly set these actions, it is noted that some embodiments of the camera may utilize a fixed aspect imaging device which may automatically capture quality images without requiring a defined exposure, zoom, and/or focus setting.

It is noted that the commands received at step 508 may be received at various times. In some embodiments, such as described above, the commands may be received via a removable memory device inserted into the camera. Thus the camera need not even be turned on to receive the commands. Likewise, one or more commands may be received while the camera is activated. For example, one or more capture sequences may be updated, deleted, or added in this manner.

At a step 512, the camera may begin monitoring for objects in its detection zones. This may include activating one or more of the camera's sensors. At a decision step 516, if an object is detected one or more capture sequences 544 may occur, such as shown. If no object is detected, the camera may continue monitoring at step 512.

If an object is detected, the zone or zones in which the object was detected may be determined in a step 520. This may occur in various ways. In one embodiment, the sensor which detected the object may indicate which of the zones the object is in. To illustrate, referring to FIG. 4, it can be seen that each detection zone corresponds to a sensor. Thus, the sensor that detects an object identifies which zone the object is in. It is noted that two or more sensors may detect the object, such as if the object is in an overlap area. In such case, the sensors that detected the object may be used to identify which zones the object is in. If multiple objects are detected, each object, the zone or more zones in which they were detected may be determined as well.

The imaging device and sensors may be calibrated to have corresponding capabilities. For example, the detection zone of a sensor may be calibrated to match the view captured by the imaging device, or vice versa. In this manner, moving the imaging device to a particular zone ensures that everything in the detection zone is captured by the imaging device. This is advantageous in that it ensures that an object detected in a zone is captured even if the object is at the edges or fringes of the zone.

One or more capture sequences 544 may then be executed. Though shown as including particular steps by the dashed box in FIG. 5, it is contemplated that a capture sequence may include various steps or operations, such as described herein. For example, a capture sequence may include tagging an image, which will be described further below. It is noted that one or more capture sequences may be retrieved from a storage device of the camera for execution based on various criteria. For example, different capture sequences may be retrieved for execution depending on which zone or zones an object was detected in. Some other exemplary criteria include the time of day, ambient light level, visibility, wind, humidity, and other environmental conditions. It is noted that these criteria may also or alternatively be used in the capture sequences (such as in one or more conditional instructions) such as to define image capture, imaging device movement, and illuminator actions.

At a step 524, the imaging device may be moved to a particular position according to the capture sequence. For example, if the capture sequence instructs the imaging device to move to the zone in which the object was detected, the imaging device will so move in step 524. It is noted that typically the imaging device will at some point be moved to the zone in which the object was detected to capture one or more images there. It is also noted that that zone need not be the zone the first image or images are capture in. For example, an image may be captured at the imaging device's current position and then at the zone in which the object was detected (after the imaging device has been moved there).

At a step 528, one or more images may be captured. Again, the capture sequence may define the number of images captured and zoom, focus, or other imaging device settings. The capture sequence may also define a variable number of images to be captured based on the favorability or unfavorability of visibility, light, or other conditions, such as described above.

At a decision step 532, it may be determined whether or not a capture sequence is complete. As stated above, a capture sequence may include one or more imaging device movements to capture images at various imaging device positions. Thus, at decision step 532, if the capture sequence is not complete, the imaging device may be moved to another position at step 524 where one or more additional images may be captured at step 528. Imaging device movement and image capture (as well as other capture sequence) steps may be repeated until the capture sequence is complete at decision step 532.

If at decision step 532 the capture sequence is complete, the captured image(s) may be processed and/or tagged at a step 536. For example, captured images from a capture sequence may be processed to improve or alter their color, exposure, or other attributes. As another example, if the capture sequence was a panoramic sequence, the images captured may be stitched together as part of the processing of step 536.

Images may also be tagged at step 536. In general, tagging identifies one or more particular images from the other images that have been captured. In one or more embodiments, the particular images may be those that are more likely or that actually contain the object that was detected. For example, in a capture sequence spanning multiple zones, only image(s) capture in the zone at which the object was detected may be tagged. This allows these images (which contain the object) to be easily selected and viewed out of the remainder of the images that have been captured. This is highly advantageous especially where there are numerous images to review. It is noted that tagging and/or processing of images may occur as part of a capture sequence. For example, images may be processed and/or tagged after they have been captured.

Tagging may occur in various ways. In one embodiment for example, the image files may have a “tag” written or associated therewith. In another embodiment, tagged images may be stored in a different directory, folder, storage device, or data storage area than untagged images. In yet another embodiment, a list or database may be maintained by the camera which identifies tagged images, such as by their filename or other identifier.

At a step 540, captured images may be stored on a storage device. Typically this will be a storage device internal to the camera so that the camera does not rely on an external device to operate. It is contemplated that a remote storage device could be used in some embodiments however. The step of storing an image may also occur as part of a capture sequence. For example, a copy of a captured image may be stored right after it has been captured. Additional copies of the image may then be stored as well, such as a copy of a processed version of the image or a stitched together panorama of a number of captured images. Tagging may occur before or after the image has been stored.

Once a number of images have been stored, a user may view them. In one or more embodiments, the camera may provide a view screen, such as an LCD or other display, through which the captured images may be displayed. In addition or alternatively, the camera may have a communication device that may be used to transmit images to other devices for viewing. Alternatively or in addition, a removable storage device on which the images have been stored can be removed from the camera and inserted into another device for viewing or other operations. For example, the storage device may be a flash memory stick, USB memory, hard drive, optical media, or other storage medium that is readable via another device, such as a computer, printer, or the like.

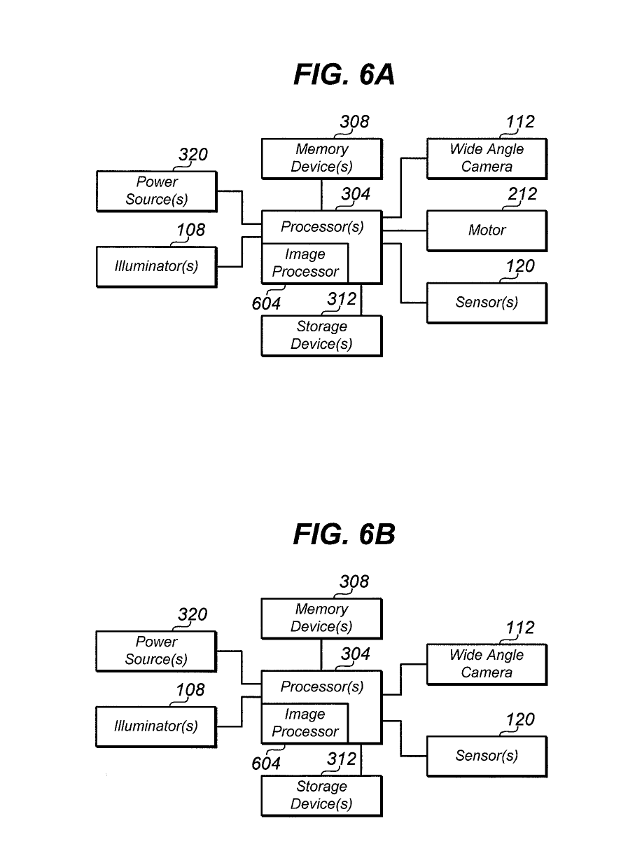

In one or more embodiments, the camera may utilize particular imaging devices 112 (such as cameras and other image capture devices) to provide a large field of view. For example, referring to FIGS. 6A-6B, a wide angle imaging device 112 may be provided. In one or more embodiments, the wide angle imaging device 112 may have a wide angle lens, such as a fish eye lens or the like to provide a wide field of view. The wide angle imaging device 112 may provide various wide fields of view. For example, in one embodiment, the imaging device 112 may provide a viewing angle of 130 or 140 degrees, or larger. This is advantageous in that a larger area can be captured in a single image.

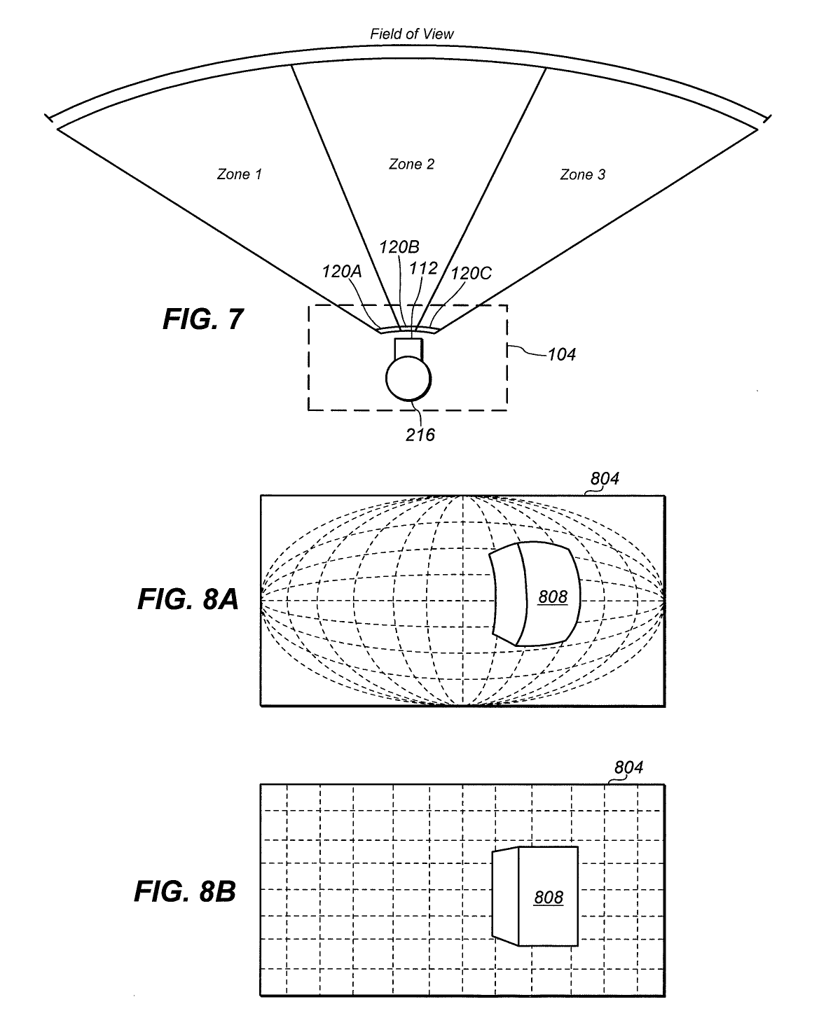

FIG. 7 illustrates an exemplary camera 104 having a wide angle imaging device 112. As can be seen, the wide angle imaging device 112 provides a large field of view. In one or more embodiments, the field of view is large enough that the wide angle imaging device 112 need not be rotatably mounted. In other words, the wide angle imaging device 112 may have a fixed mount. As can be seen from FIG. 7 for instance, the wide angle imaging device 112 has a field of view large enough to capture images from every detection zone provided by the camera's sensors 120A,120B,120C. In this manner, the wide angle imaging device 112 need not be rotated to capture an image of an object detected in Zones 1, 2, or 3. It is noted that the wide angle imaging device 112 may be rotatably mounted as well, such as to allow the wide angle imaging device to capture images of detection zones outside its wide field of view.

Referring back to FIGS. 6A-6B, it can be seen that an image processor 604 may be provided to correct any image distortion created by a wide angle imaging device 112. For example, as shown, the processor 304 may have a portion of its hardware configured for image processing. In addition, instead or in addition to be hardwired to perform image processing, the processor 304 may execute one or more instructions or machine readable code (e.g., software) to process images. The instructions or machine readable code may be stored on a storage device 312. Where instructions or machine readable code is executed, it is contemplated that the processor's hardware need not (but may be) specially configured to perform image processing. For example, a portion of the processor's circuitry may be configured to perform image processing. It is also contemplated that a separate hardware image processor may be provided in some embodiments. For example, integrated circuit separate from the processor 304 could be provided in some embodiments to perform image processing.

In general, the image processor 604 will receive one or more images from the imaging device 112 and process the images to remove distortion. For instance, the wide angle imaging device 112 may capture a radially distorted image in providing an image with a wide field of view. For example, the image may be radially distorted in the shape of a sphere, tapered cylindrical, combinations thereof, or other rounded shapes, such as shown in the example of FIG. 8A. As can be seen in FIG. 8A, an image 804 of a rectangular object 808 is radially distorted such that it appears to be on the curved surface shown by the broken lines in FIG. 8A. In the radially distorted image, straight lines appear curved however a wide field of view is captured.

FIG. 8B shows the image 804 including the rectangular object 808 after the image has undergone image processing to remove distortion introduced by a wide angle imaging device 112. As can be seen, image processing has straightened the curve of the rectangular object 808 and the remainder of the image 804 to produce the undistorted or substantially less distorted image of FIG. 8B. For instance, the rectangular object 808 now has straight lines as it would in the real world.

FIG. 8A shows that a wide angle imaging device 112 can be used to capture one or more radially distorted images with a wide field of view which is advantageous in capturing as much information as possible before the imaging device 112 must be moved. Alternatively or in addition the wide field of view may reduce or eliminate the need to move the imaging device 112 and the hardware associated with executing such movement. Referring back to FIG. 6B for instance, it can be seen that in some embodiments the wide angle imaging device 112 need not have a motor or be rotatably mounted. In such embodiments, it is contemplated that the wide angle imaging device 112 may be mounted in a fixed or non-rotatable manner.

In FIG. 8B, it can be seen that the radial distortion may be removed with image processing resulting in a rectilinear image. In the field of wildlife/outdoor cameras, surveillance cameras, and the like this allows the imaging device 112 to quickly and efficiently capture a wide distortion-free view of an area. This is advantageous in that it increases the amount of information captured in each image.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A motorized camera comprising:
an imaging device comprising a wide angle lens for capturing radially distorted images with a wide field of view;
a motor operably coupled to the imaging device to move the imaging device;
a plurality of sensors arranged to detect the presence of an object at one or more of a plurality of distinct areas, and to generate output identifying a particular area of the plurality of distinct areas when the object is detected;
a processor that receives the output and moves the imaging device with the motor to target the particular area identified in the output and one or more adjacent areas in sequence, wherein the imaging device captures a first radially distorted image of the particular area and one or more second radially distorted images of the one or more adjacent areas during the sequence; and
an image processor that converts the first radially distorted image and the one or more second radially distorted images into rectilinear images.

2. The motorized camera of claim 1 further comprising a storage device that stores the rectilinear images.

3. The motorized camera of claim 1, wherein the object is an animal or other wildlife.

4. The motorized camera of claim 1 further comprising a watertight enclosure.

5. The motorized camera of claim 1 further comprising an internal power source.

6. The motorized camera of claim 1 further comprising one or more illuminators arranged to illuminate one or more of the plurality of distinct areas.

7. The motorized camera of claim 1, wherein the processor also positions the rectilinear images adjacent to one another to generate a single combined image.

8. The motorized camera of claim 1 further comprising a rotatable mount that supports the imaging device.

9. A motorized camera comprising:
an imaging device comprising a wide angle lens that captures radially distorted images with a wide field of view;
one or more sensors arranged to detect the presence of an object at each of a plurality of areas and, when detected, to identify a particular area of the plurality of areas where the object is present;
a motor operably coupled to the imaging device, wherein the motor moves the imaging device to target the particular area and one or more other areas in sequence, and the imaging device captures a first radially distorted image of the particular area and one or more second radially distorted images of the one or more other areas during the sequence; and
a processor that converts the first radially distorted image and the one or more second radially distorted images into rectilinear images.

10. The motorized camera of claim 9 wherein the processor positions the rectilinear images adjacent to one another to generate a single combined image.

11. The motorized camera of claim 9 further comprising a storage device that stores the rectilinear images.

12. The motorized camera of claim 9, wherein the object is an animal or other wildlife.

13. The motorized camera of claim 9 further comprising a watertight enclosure.

14. The motorized camera of claim 9 further comprising an internal power source.

15. The motorized camera of claim 9 further comprising one or more illuminators arranged to illuminate one or more of the plurality of distinct areas.

16. The motorized camera of claim 9 further comprising a rotatable mount that supports the movable imaging device.

17. A motorized camera implemented method comprising:
monitoring a plurality of distinct areas with one or more sensors for the presence of an object;
detecting the object at a particular area of the plurality of distinct areas with the one or more sensors;
moving an imaging device comprising a wide angle lens that captures radially distorted images with a wide field of view, wherein the imaging device is moved with a motor based on output from the one or more sensors;
capturing a first radially distorted image of the particular area and one or more second radially distorted images of one or more other areas with the imaging device;
converting the first radially distorted image and the one or more second radially distorted images into rectilinear images.

18. The motorized camera implemented method of claim 17 further comprising storing the rectilinear images on a storage device.

19. The motorized camera implemented method of claim 17 further comprising positioning the rectilinear images adjacent to one another to generate a single combined image.

20. The motorized camera implemented method of claim 17 further comprising activating one or more illuminators upon detecting the object.
